(19) United States
(12) Patent Application Publication
(10) Pub. No.: US 2007/0066146 A1
(43) Pub. Date: Mar. 22, 2007

(54) Socket for c-type light bulb

(76) Inventor: Ho-Hsin Chiu, Hsin Chu City (TW)

Correspondence Address: LEONG C LEI, PMB # 1008, 1867 YGNACIO VALLEY ROAD, WALNUT CREEK, CA, 94598, US

(21) Appl. No.: 11/230,656

(22) Filed: Sep. 21, 2005

(51) Int. Cl. H01R 24/00

(52) U.S. Cl. 439/699.2

(57) ABSTRACT

A socket for a c-type light bulb is disclosed. The socket comprises a soft core and a mounting head, and the soft core allows the light bulb to be firmly inserted, and the pins of the light bulb pass through the bottom end of the soft core and are bent at a position for securing. The mounting head is firmly secured without dislocation and is firmly inserted to form as a unit with the soft core, and the bent section of the pins press the surface of the wire terminal so that electrical connection of the c-type light bulb is formed.

### BACKGROUND OF THE INVENTION

(a) Technical Field of the Invention

The present invention relates to a socket for c-type light bulb, and in particular, a socket which is used for the mounting of a c-type light bulb with a flat section for insertion onto the socket.

(b) Description of the Prior Art

Referring to FIG. 7, there is shown a convention socket where the pin section of the light bulb is adhered with a threaded copper nut 1, and the socket 2 has internal threads. This type of bulb needs plenty of copper material and requires complicated processes, and therefore the production cost is high. Further, the copper nut 1 is easily oxidized and therefore the conductivity is poor. In some cases, the screwing of the light bulb onto the socket is too tight, and therefore dislocation of the bulb and the socket is often occurred.

As shown in FIG. 8, a flat section 4 having pins is provided to the c-type light bulb. The surface of the flat section is a recess 5 and is formed with the socket 6 as one unit, allowing the c-type light bulb to be positioned, and the socket 6 allows the wire terminal 7 to be fastened. The conventional light bulb and the socket could mitigate the drawback of the conventional screwing type of mounting, however, the glass surface is too smooth and the bending section of the pins of the light bulb may be tilted easily and therefore poor contact is often occurred. Thus, the light bulb needs to be replaced very often. Accordingly, it is an object of the present invention to provide a socket for c-type light bulb which solve the above mentioned drawbacks.

### SUMMARY OF THE INVENTION

The primary purpose of the present invention is to a socket for c-type light bulb comprising a connectable soft core and a mounting head, characterized in that the soft core has an insertion slot at the interior of the soft core, and the exterior of the soft core is a rubber housing body having an upper block and an engaging section, and the insertion slot includes an upper section and a lower section, and the upper section is for the mounting of the circular arch section of the bulb housing, and the lower section is a complimentary shape for the mounting of the flat section of the bulb housing such that the pins of the bulb housing is vertically protruded from the bottom face of the soft core, and the upper block is stopped at the top edge of the mounting head so as to restrict the depth of mounting; the engaging section is a cylindrical body with rotating engaging corner; and the mounting head has an interior provided with a cavity for holding the soft core, and the bottom of the head is a through hole for the insertion of wire, and a rubber plug is used to seal the through hole, and the shape of the slot is a complimentary shape to the lower portion of the upper block and the wall face of the cavity is a recess for fastening a wire terminal; whereby the light bulb socket allows the c-type light bulb, the soft core and the mounting head to be firmly mounted together without dislocation and the bending section of the pins of the light bulb is firmly pressing on the surface of the wire terminal.

Yet another object of the present invention is to provide a socket for c-type light bulb, wherein the flat section of the c-type light bulb is provided with a recess so as to adapt to a protruded edge on the wall face of the lower section of the light bulb insertion slot.

Still another object of the present invention is to provide a socket for c-type light bulb, wherein the external edge of the upper block is provided with an engaging peg, and the external edge wall of the mounting head is a guiding slot to accommodate the engaging peg.

A further object of the present invention is to provide a socket for c-type light bulb, wherein the bottom face of the engaging section of the plug is extended to form a pair of engaging hook, and the wall face of the cavity is a protruded stripe for engagement.

Still a further object of the present invention is to provide a socket for c-type light bulb, wherein the bottom end of the soft core has a pair of through holes for the pins of a light bulb, and the external edge of the hole has a V-shaped slot for the positioning of the bending pins of the light bulb.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1A & 1B is a perspective view of the preferred embodiment of the present invention.

FIG. 2 is a sectional view showing the components of the preferred embodiment in accordance with the present invention.

FIG. 3 is another sectional view showing the components of the preferred embodiment in accordance with the present invention.

FIG. 4 is a perspective view showing the combination of the components in accordance with the present invention.

FIG. 5 is a perspective view of the present invention.

FIG. 6 is a sectional view showing the interior of the socket of the present invention.

FIG. 7 is a conventional mounting of a c-type light bulb onto a socket.

FIG. 8 is a conventional mounting of the c-type light bulb with the socket.

FIG. 9 is a schematic view showing the tilting of the pins of a conventional light bulb.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

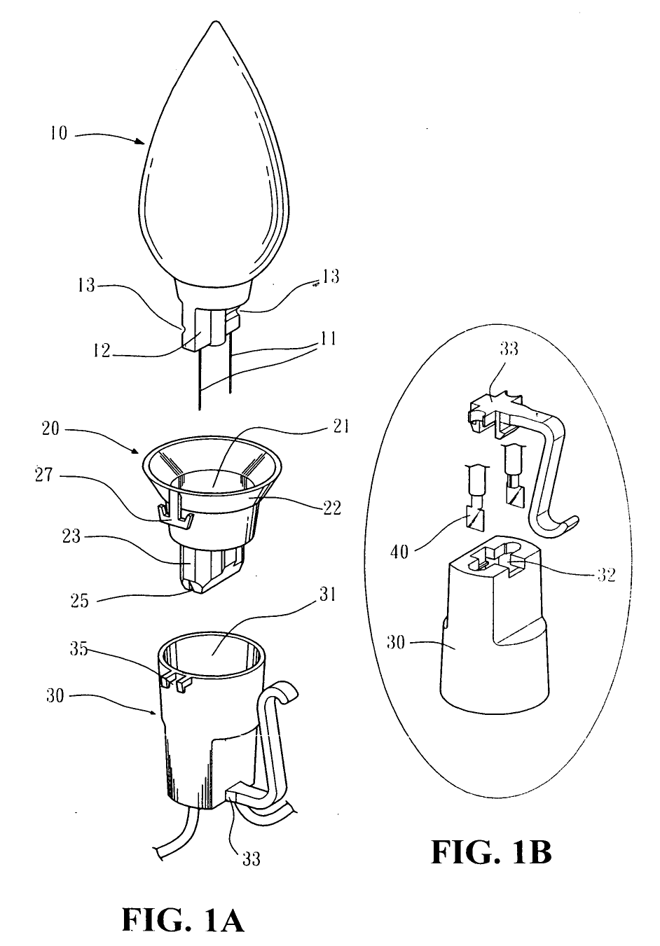

Referring to FIGS. 1A & 1B, the socket in accordance with the preferred embodiment of the present invention is for electrical connection with c-type light bulb 10 having a flat section 12 at the pivoted end of the pin 11. The socket includes a soft core 20 for connection with the c-type light bulb 10, and a mounting head 30 for the mounting of the soft core and for the positioning of the wire terminal.

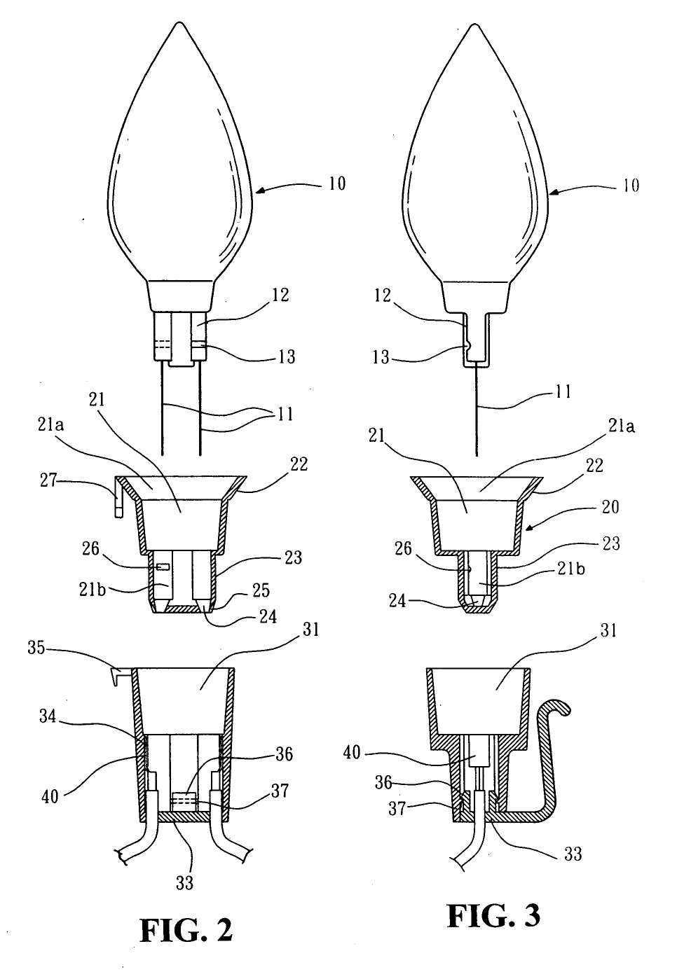

As shown in FIGS. 1A, 1B, 2 and 3, the interior of the soft core 20 has a light bulb insertion slot 21, and the external thereof is a housing body having an upper block 22 and an engaging section 23. The insertion slot 24 includes an upper and a lower section. The upper section 21a provides firm mounting with the arch shaped section of the light bulb housing and the lower section 21b has a shape complimentary to the upper section 21a such that the flat section 12 of the light bulb housing can be positioned. The bottom end of the insertion slot is provided with through holes 24 for pins, and the external edge of the holes 24 is provided with a V-shaped guiding slot 25 such that the light bulb pins 11 can be vertically protruded out from the bottom face of the soft core, and the pins 11 are guided by the V-shaped slot 25 and positioned. The external diameter of the upper block 22 is larger than the opening of the top edge of the mounting head 30 so as to limit the depth of mounting. The engaging section 23 is a cylindrical shape with rotating engaging corners.

The interior of the mounting head 30 is provided with a cavity 31 to hold the soft core and the bottom section is provided with wire through hole 32, and a rubber plug 33 is used to seal the through hole. The shape of the soft core slot 31 is a compliment shape to mount with the lower section of the upper block 22 of the soft core 20, such that the soft core will not rotate and is firmly mounted onto the mounting head 30. As shown in FIG. 2, the soft core is provided at the wall face corresponding to the bending section of the pins 11, and is provided with a positioning recess 34 for mounting with the wire terminal 40.

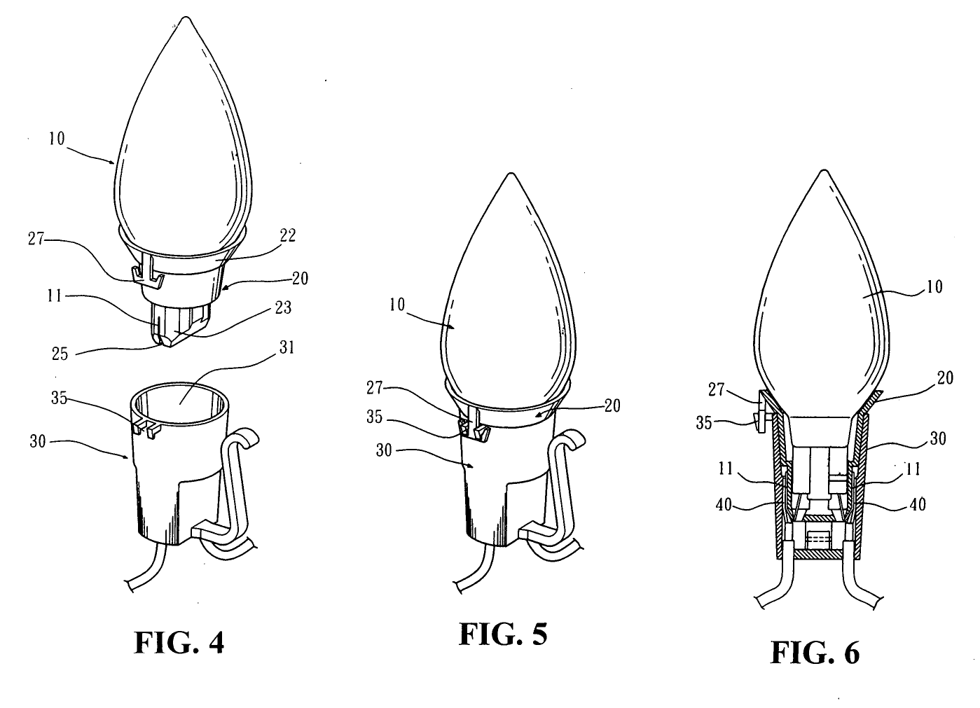

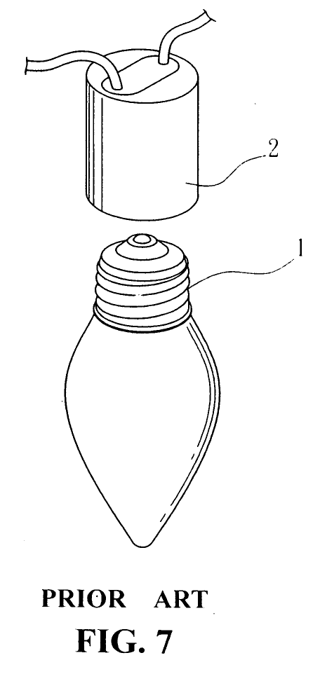

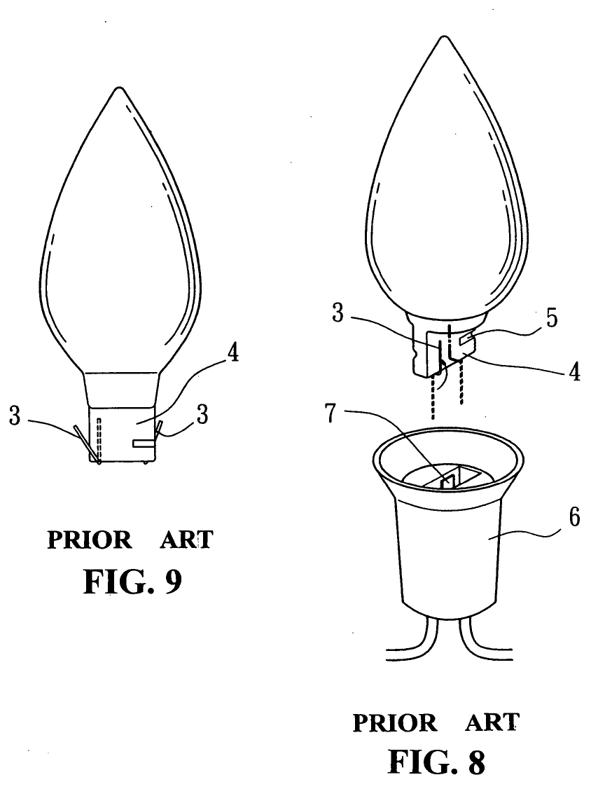

Referring to FIGS. 4, 5 and 6, the c-type light bulb C is mounted at the soft core 20 and the pins 11 are guided by the V-shaped slot 25 and positioned. After that, the light bulb is inserted onto the soft mounting head 30, i.e., the pins 11 of the light bulb 11 are firmly pressed onto the surface of the wire terminal 40. The electrical connection of the c-type light bulbs is completed.

In accordance with the present invention, the c-type light bulb, the surface of the flat section 12 is provided with recess 13, and the wall face of the lower section 21b of the insertion slot is a protruded edge 26 for mounting with the recess such that no dislocation is formed. As shown in FIGS. 4, 5, and 6, the external edge face of the upper block 22 of the soft core 20 is provided with an engaging peg 27 and the external top edge of the mounting head 30 is a guiding slot 35 which is corresponding to the engaging peg such that the mounting between the soft core 20 and the mounting head 30 will not be dislocated. As shown in FIGS. 1, 2 and 3, in order to allow the plug 33 to be inserted easily but shall have difficulty in pulling out, the bottom end of the plug 33 is provided with an engaging hook 36 and the wall face of the cavity 31 is provided with a protruded stripe for engaging with the engaging hook 36.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A socket for c-type light bulb comprising a connectable soft core and a mounting head, characterized in that the soft core has an insertion slot at the interior of the soft core, and the exterior of the soft core is a rubber housing body having an upper block and an engaging section, and the insertion slot includes an upper section and a lower section, and the upper section is for the mounting of the circular arch section of the bulb housing, and the lower section is a complimentary shape for the mounting of the flat section of the bulb housing such that the pins of the bulb housing is vertically protruded from the bottom face of the soft core, and the upper block is stopped at the top edge of the mounting head so as to restrict the depth of mounting; the engaging section is a cylindrical body with rotating engaging corner; and
the mounting head has an interior provided with a cavity for holding the soft core, and the bottom of the head is a through hole for the insertion of wire, and a rubber plug is used to seal the through hole, and the shape of the slot is a complimentary shape to the lower portion of the upper block and the wall face of the cavity is a recess for fastening a wire terminal;
whereby the light bulb socket allows the c-type light bulb, the soft core and the mounting head to be firmly mounted together without dislocation and the bending section of the pins of the light bulb is firmly pressing on the surface of the wire terminal.

2. The socket for c-type light bulb of claim 1, wherein the flat section of the c-type light bulb is provided with a recess so as to adapt to a protruded edge on the wall face of the lower section of the light bulb insertion slot.

3. The socket for c-type light bulb of claim 1, wherein the external edge of the upper block is provided with an engaging peg, and the external edge wall of the mounting head is a guiding slot to accommodate the engaging peg.

4. The socket for c-type light bulb of claim 1, wherein the bottom face of the engaging section of the plug is extended to form a pair of engaging hook, and the wall face of the cavity is a protruded stripe for engagement.

5. The socket for c-type light bulb of claim 1, wherein the bottom end of the soft core has a pair of through holes for the pins of a light bulb, and the external edge of the hole has a V-shaped slot for the positioning of the bending pins of the light bulb.
